(19) United States
(12) Patent Application Publication
(10) Pub. No.: US 2015/0064051 A1
(43) Pub. Date: Mar. 5, 2015

(54) EMBOSSMENT STRUCTURE FORMED IN A MOLD AND ITS MANUFACTURING METHOD

(71) Applicants: SHENG-CHANG HUANG, (US); SUPREME TECHNIC PACKAGE CO., LTD., KAOHSIUNG CITY (TW)

(72) Inventor: SHENG-CHANG HUANG, KAOHSIUNG CITY (TW)

(73) Assignees: SUPREME TECHNIC PACKAGE CO., LTD., KAOHSIUNG CITY (TW); SHENG-CHANG HUANG, KAOHSIUNG CITY (TW)

(21) Appl. No.: 14/011,482

(22) Filed: Aug. 27, 2013

(51) Int. Cl. B22F 3/02; B22F 5/00; B29C 37/00

(52) U.S. Cl. CPC B22F 3/02; B29C 37/0053; B29C 37/0017; B22F 5/00; B29K 2101/12
USPC 419/66; 264/334; 264/330; 264/328.1; 264/509

(57) ABSTRACT

A manufacturing method of an embossment structure formed in a mold in the present invention is applicable to plastic or metallic in-mold shaping products, such as computers, communication products, consumer electronic products, electrical appliances, parts of machines and instruments or common household products. A base layer provided with embossment structure or tri-dimensional ornament and a separable layer is stably fixed in a shaping mold by making use of absorption mode of the shaping mold. After shaped completely, the base layer on the surface of the in-mold shaping product is torn off to present delicate tri-dimensional embossed streaks on the surface of the in-mold shaping product, which is designed according to personalization or individuation, able to lower cost and increase external beauty of the in-mold shaping product and conform to economic gain.

### BACKGROUND OF THE INVENTION

1. Field of the Invention

This invention relates to an embossment structure formed in a mold and its manufacturing method, particularly to one having a base layer provided thereon with embossment structure or tri-dimensional ornament and a separable layer. The base layer is stably fixed in a shaping mold by making use of absorption mode of the shaping mold to have the embossment structure or the tri-dimensional ornament on the base layer formed integrally on the surface of a plastic or metal in-mold shaping product. After shaped, the base layer on the surface of the in-mold shaping product is torn off to have the surface of the plastic or metal in-mold shaping product producing exquisite embossed streaks.

2. Description of the Prior Art

A conventional technique of having 3-D ornament formed on the surface of an in-mold shaping product, as disclosed in a Taiwan patent No. 1274651, titled “Manufacturing Method of Shaping an Anti-Forgery Label in Mold” is to have the mold cavity of a shaping mold forming concave portions or convex portions and then an in-mold shaping label is deposited in the mold cavity. During shaping in mold, pressure of high temperature plastic injected in a mold enables the outer surface of a plastic in-mold shaping product to produce corresponding 3-D streaks. Although the outer surface of a male mold and the inner surface of a female mold of the shaping mold are respectively provided with concave portions and convex portions, it can attain the objective of manufacturing a product with quickness and in great quantity. But more and more commercial products are manufactured for matching personalization or individuation in the wake of the progress of science and technology and the enhancement of consumer's needs, such as plastic shells of computers, communication products, consumption electronic products, electric appliances or mechanical parts, or in-mold shaping products like cups, cup pads, bottles, boxes or containers. However, if a set of mold is manufactured only for producing one sort of product of personalization or individuation, the cost needed for making the mold is extremely high, and the set of mold, after used, cannot be employed for producing other commercial products, not conforming to economic gain.

A second technique of having 3-D ornament formed on the surface of an in-mold shaping product, as disclosed in a Taiwan patent No. 1259418, titled “Manufacturing Method of Anti-Fake Labels And Anti-Fake Products”, is to have an in-mold shaping label provided with an internal ornament layer and a separable layer bored with a through hole. After the in-mold shaping label is set in the mold cavity, pressure of high-temperature plastic injected for shaping in the mold enables the plastic to be combined with an internal ornament layer and to squeeze the internal ornament layer through a through hole of the separable layer, letting the internal layer produce a bulgy shape. After the plastic and the label are shaped and the separable layer is torn apart, a plastic product with a bulgy shape can be obtained. A third conventional technique of having 3-D ornament formed on the surface of an in-mold shaping product, as disclosed in a Taiwan patent No. 586089, titled “Manufacturing Method of Anti-Fake In-Mold Shaping Labels And Anti-Fake Products”, is to have the outer surface of an in-mold shaping label provided with an ornament with a certain thickness. Since the ornament is comparatively thick; therefore, when the label is shaped in the mold, the pressure of high-temperature plastic injected in the mold will squeeze the label to make the label deformed and become consistent with the surface of the ornament. After the plastic product is shaped and removed out and the ornament is torn off, the surface of the plastic product will produce a 3D effect of a concave portion. However, the above-mentioned two kinds of conventional techniques employed for shaping labels in a mold both are to have the outermost layer of a label structure provided with a separable layer or an ornament, which is bored with a through hole. When the label is being shaped in the mold, the internal layer structure of the label will be combined with the thermal plastic injected into the mold so the plastic will not be combined with the separable layer or the ornament of the label. Blocked by the internal layer structure of the label, high pressure produced by plastic injected in the mold will be impeded by the internal layer of the label when the high pressure squeezes the through hole of the separable layer or the edge of the ornament. As a result, the separable layer or the edge of the ornament can only produce simple and rough concavo-convex streaks on the surface of the plastic product but cannot completely present comparatively delicate 3-D patterns or characters, the simple and rough concavo-convex streaks only able to serve as simple anti-counterfeiting, identification or simple decoration. In addition, the biggest problem of the conventional techniques is that the surface of a plastic product to be manufactured must be combined with a label; otherwise the separable layer with a through hole or the ornament will be combined with the plastic product to produce flaws and thus, plastic products that are needless to be provided with the layer of label are impossible to produce 3D streaks smoothly.

In view of foresaid drawbacks of the conventional techniques, the inventor of this invention, having accumulated many years of experience related to embossment structure formed in a mold and its manufacturing method, has been dedicated to research of the technical problem of how to make it possible for a shaping mold and an in-mold shaping label to have the surface of an in-mold shaping product producing delicate 3-D patterns or characters, thus devising this invention.

### SUMMARY OF THE INVENTION

The objective of this invention is to offer an embossment structure formed in a mold and its manufacturing method, able to have the surface of an in-mold shaping product producing delicate tri-dimensional patterns or characters similar to an embossed work of art under a condition that it is needless to provide a label. This invention can solve the problems of the prior art that the cost of making molds is too high, that a label must be provided on the surface of the in-mold shaping product for forming tri-dimensional streaks and that an in-mold shaping label is impossible to present delicate patterns and characters. The manufacturing method of an embossment structure formed in a mold of this invention is applicable to plastic or metal in-mold shaping products.

A first manufacturing method of an embossment structure formed in a mold in the present invention includes the following steps: A first step is to have the plate-structured base layer provided with an inner surface and an outer surface, and the base layer has the inner surface engraved with carving streaks and disposed with a separable layer. A second step is to have one side of the base layer, which is provided with no separable layer, fixed in an absorption mode at the wall surface of a shaping mold. A third step is to combine a female mold and a male mold of the shaping mold together and have fluid thermal plastic poured into the shaping mold to form embossed streaks on the surface of a plastic in-mold shaping product, and a fourth step is to remove out the plastic in-mold shaping product after shaped completely and have both the base layer and the separable layer torn off the surface layer of the plastic in-mold shaping product to present embossed streaks on the surface layer of the plastic in-mold shaping product.

A second manufacturing method of an embossment structure formed in a mold in the present invention includes the following steps: A first step is to have a base layer formed with an inner surface and an outer surface. The base layer has its outer surface provided with a tri-dimensional ornament and its inner surface disposed with a separable layer. A second step is to have one side of the base layer, where no separable layer is provided, set with the absorption method at the wall surface of a shaping mold. A third step is to combine the female mold and the male mold of the shaping mold together and have fluid thermal plastic poured into the shaping mold for forming embossed streaks on the surface of a plastic in-mold shaping product, and a fourth step is to remove the plastic in-mold shaping product from the shaping mold after shaped and have both the base layer and the separable layer torn off the surface layer of the plastic in-mold shaping product to present embossed streaks on the surface layer of the plastic in-mold shaping product.

A third manufacturing method of an embossment structure formed in a mold in the present invention includes the following steps: A first step is to have a metal-plate base layer provided with an inner surface and an outer surface, and the inner surface of the base layer is engraved with carving streaks. The base layer further has its inner surface provided with a separable layer made of wax that is able to bear high temperature and high pressure when a metal in-mold shaping product is being shaped. A second step is to have one side of the base layer, which is provided with no separable layer, secured in magnetic absorption mode at the wall surface of a shaping mold. A third step is to have a female mold and a male mold of the shaping mold combined together and have metal powder poured into the shaping mold with injection molding method to form embossed streaks on the surface of the metal in-mold shaping product, and a fourth step is to remove the metal in-mold shaping product from the shaping mold and have both the base layer and the separable layer on the surface layer of the metal in-mold shaping product torn off to present embossed streaks on the surface layer of the metal in-mold shaping product.

Thus, the manufacturing method of an embossment structure formed in a mold can have the inner and the outer surface of a metal or a plastic in-mold shaping product producing embossed streaks under a condition that it is unnecessary to provide a shaping label in mold, thus needless to repeatedly replace molds for designs of different patterns or characters and able to economize resources.

### BRIEF DESCRIPTION OF DRAWINGS

This invention will be better understood by referring to the accompanying drawings, wherein:

FIG. 1 is a cross-sectional view of a first or a second preferred embodiment of an embossment structure formed in a mold in the present invention;

FIG. 2 is a cross-sectional view of a third preferred embodiment of an embossment structure formed in a mold in the present invention;

FIG. 3 is a schematic view of the embossment structure formed in a mold in the present invention, illustrating that a base layer of the embossment structure is combined with a female mold;

FIG. 4 is a schematic view of the base layer of the embossment structure formed in a male mold in the present invention, illustrating that the base layer is to be combined with a male mold;

FIG. 5 is a schematic view of the embossment structure formed in a mold in the present invention, illustrating that the base layer is to be combined with both the female mold and the male mold;

FIG. 6 is a schematic view of the embossment structure to be formed in a mold in the present invention; FIG. 7 is a schematic view of the embossment structure formed in a mold in the present invention, illustrating that both the base layer and a separable layer on the surface of an in-mold shaping product are torn off;

FIG. 8 is a perspective view of a first preferred embodiment of an embossment structure formed integrally with an in-mold shaping product in the present invention;

FIG. 9 is a perspective view of a second preferred embodiment of an embossment structure formed integrally with an in-mold shaping product in the present invention; and

FIG. 10 is a perspective view of a third preferred embodiment of an embossment structure formed integrally with an in-mold shaping product in the present invention.

### DETAILED DESCRIPTION OF THE PREFERRED EMBODIMENT

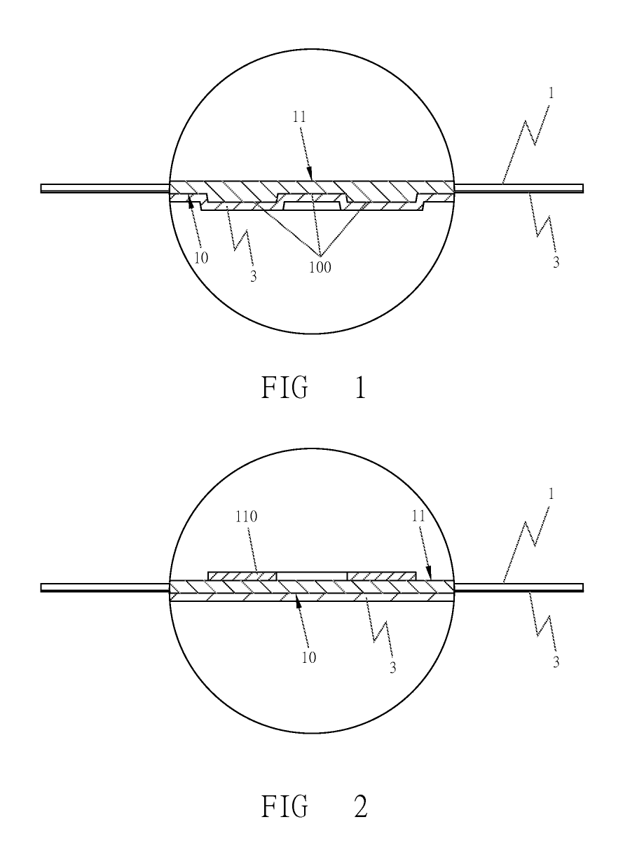

A first preferred embodiment of a manufacturing method of an embossment structure formed in a mold in the present invention, as shown in FIGS. 1 and 3-8, at least includes following steps:

A first step is to have a base layer 1 formed with an inner surface 10 and an outer surface 11. The base layer 1 different from a plastic in-mold shaping product in material is a plate that is of high hardness, able to be engraved and of ductility (able to be torn off), such as a metal plate, an acrylic sheet, a cardboard or a plank. The shape of the base layer 1 can be a planar shape, a curved surface shape, a circular shape or an irregular shape for matching the shape of a shaping mold 4. The base layer 1 has the inner surface 10 engraved with carving streaks 100 manually or by an engraving machine for engraving various kinds of exquisite patterns and characters, and the carving streaks 100 are partially or completely engraved on the inner surface 10 of the base layer 1 in a mode of intaglio relief, alto-relievo or embossing, letting the carving streaks 100 presented by the base layer 1 become enriched and diversified. Further, the inner surface 10 of the base layer 1 is provided with a separable layer 3 made of oily material or non-adherent material, such as isolating oil film, wax or plio-film. The separable layer 3 is covered on the carving streaks 100 to insure that, in a shaping process in a mold, the plastic in-mold shaping product will not adhere to the carving streaks 100 of the base layer 1 for preventing the plastic in-mold shaping product and the carving streaks 100 of the base layer 1 from combining together enabling the base layer 1 to be torn off easily.

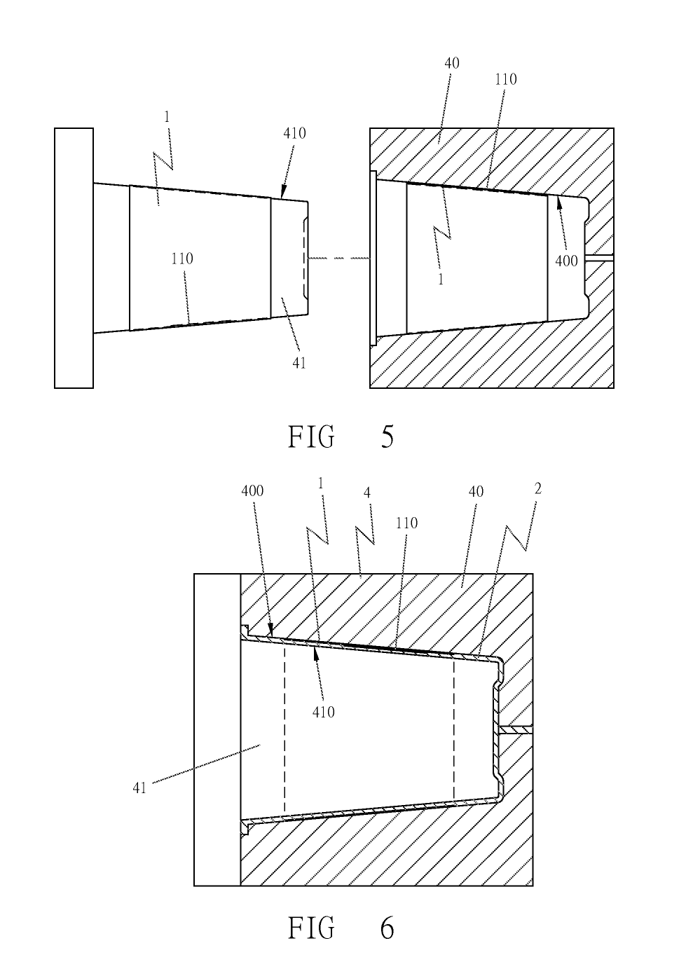

A second step is to have one side of the base layer 1, which is provided with no separable layer 3, fixed in an absorption mode at the inner wall 400 of the female mold 40 of a shaping mold 4, as shown in FIG. 3, or at the outer wall 410 of the male mold 4, as shown in FIG. 4, or at both the inner wall 400 of the female mold 40 and the outer wall 410 of the male mold 41, as shown in FIG. 5. By means of the absorption mode, the base layer 1 can tightly adhere to the shaping mold 4, able to prevent the base layer 1 from being washed away from a preset position by high-temperature hot melt plastic in a shaping process in the mold. Foresaid absorption set mode can adopt a vacuum absorption mode, an electrostatic absorption mode, a water absorption mode or a magnetic absorption mode, depending on the material of the base layer 1. For instance, a majority of materials can adopt the vacuum absorption mode or the water absorption mode, plastic or paper material able to produce an electrostatic effect can adopt the electrostatic absorption mode and metallic material can adopt the magnetic absorption mode. Foresaid absorption modes can be employed individually or combined and collocated for use to insure that the base layer 1 can be stably fixed in the shaping mold 4 for smoothly carrying out shaping work in the mold.

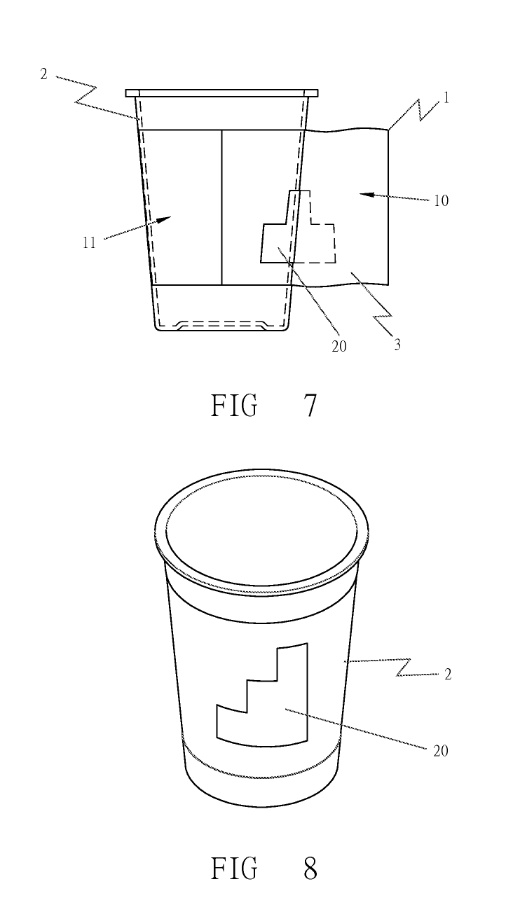

A third step is to have the female mold 40 and the male mold 41 of the shaping mold 4 combined together and have fluid thermal plastic poured into the shaping mold 4 with an in-mold shaping mode of injection molding, extrusion molding, blow molding, hollow molding or cast molding, as shown in FIG. 6, letting the plastic in-mold shaping product completely covered on the carving streaks 100 of the inner surface 10 of the base layer 1 and having the surface of the plastic in-mold shaping product 2 forming embossing streaks 20.

A fourth step is to remove the plastic in-mold shaping product 2 from the shaping mold after shaped completely. Since the base layer 1 and the plastic in-mold shaping product 2 are different in material and the separable layer 3 has an isolating effect, the plastic in-mold shaping product 2 and the base layer 1 are kept in a separable condition. After both the base layer 1 and the separable layer 3 on the surface layer of the plastic in-mold shaping product 2 are torn off, as shown in FIG. 7, the inner layer or the outer layer or both the inner and the outer layer of the plastic in-mold shaping product 2 can present embossing streaks 20, as shown in FIG. 8.

A second preferred embodiment of a manufacturing method of an embossment structure formed in a mold, as shown in FIGS. 1 and 3-10, includes following steps:

A first step is to have a base layer 1 provided with an inner surface 10 and an outer surface 11. The base layer 1 is a metal plate, and the shape of the base layer 1 matches the shape of a shaping mold, which can be a planner shape, a curved surface shape, a circular shape or an irregular shape. The base layer 1 has its inner surface 10 engraved with carving grains 100 by manual carving or by an engraving machine for engraving various delicate patterns or characters. The carving streaks 100 is partially or completely engraved on the inner surface 10 of the base layer 1 with a mode of intaglio relief, alto-relievo or embossing to enrich and diversify the carving streaks 100 presented by the base layer 1. The base layer 1 further has its inner surface 10 provided with a separable layer 3 made of wax that can bear high temperature and high pressure when metal is being shaped in a mold and thus, the separable layer 3 is used to cover the carving streaks 100 to avoid the metal in-mold shaping product 2 and the base layer 1 being pressed on each other and prevent the metal in-mold shaping product 2 from combining the carving streaks 100 of the base layer 1 to enable the base layer 1 to be torn off easily.

A second step is to have one side of the base layer 1, which is provided with no separable layer 3, set in by magnetic absorption mode at the inner wall 400 of the female mold 40 of a shaping mold 4, as shown in FIG. 3, or at the outer wall 410 of the male mold 41, as shown in FIG. 4, or at both the inner wall 400 of the female mold 40 and the outer wall 410 of the male mold 41. The magnetic absorption mode assists the base layer 1 to adhere to the shaping mold 4 tightly for preventing the base layer 1 from being washed away from a preset position by high-pressure injecting metal powder in a shaping process in the mold and producing serious flaws.

A third step is to combine the female mold 40 and the male mold 41 of the shaping mold 4 together and have fluid metal powder poured into the shaping mold in a mode of metal powder injection molding, as shown in FIG. 6. By making use of the mode of metal powder injection molding, the metal in-mold shaping product 2 can completely cover the carving streaks 100 of the inner surface 10 of the base layer 1 to have the surface of metal in-mold shaping product 2 forming embossed streaks 20 for manufacturing various kinds of metal in-mold shaping product 2 with a thin wall, high density, high precision, high mechanical strength and complex shapes.

A fourth step is to remove the metal in-mold shaping product 2 after shaped. Since the separable layer 3 provided between the base layer 1 and the metal in-mold shaping product 2, has an effect of isolation, the metal in-mold shaping product 2, after shaped, can be separated from the base layer 1. Then, both the base layer 1 and the separable layer 3 on the surface layer of the metal in-mold shaping product 2 are torn off, as shown in FIG. 7, and thus, the inner layer, the outer layer or both the inner and the outer layer of the metal in-mold shaping product 2 can present embossed streaks 20, as shown in FIG. 8. The surface of the metal in-mold shaping product 2 can also carry out polishing or backing varnish to form a polished surface or a baked varnish layer to match the embossed streaks 20 for increasing external beauty and quality feel of the metal in-mold shaping product 2.

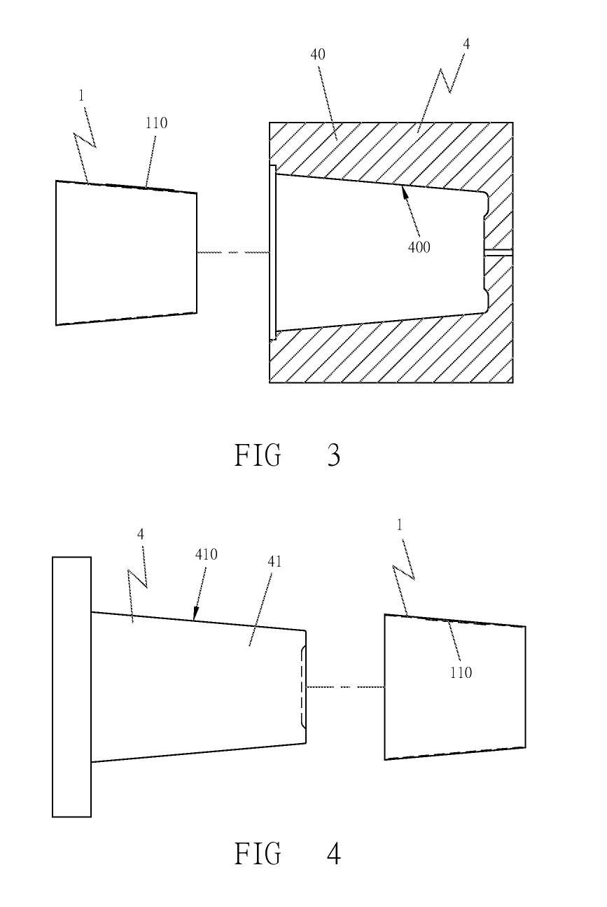

A third preferred embodiment of a manufacturing method of an embossment structure formed in a mold in the present invention, as shown in FIGS. 2 and 3-8, at least includes following steps:

A first step is to have a base layer 1 formed with an inner surface 10 and an outer surface 11. The base layer 1 is a tractile membrane different from a plastic in-mold shaping product 2 in material, such as plastic membrane or rubber membrane. The shape of the base layer 1 matching the shape of a shaping mold 4 can be a planar shape, a curved surface shape, an annular shape or an irregular shape. The base layer 1 has its outer surface 11 provided with a tri-dimensional ornament and its inner surface 10 is disposed with a separable layer 3 made of oily material or non-adherent material, different from the material of the plastic in-mold shaping product 2, such as isolating oil film or easy-tearing plio-film to avoid the plastic in-mold shaping product 2 combining with the base layer 1 in a shaping process in the mold to enable the base layer 1 to be torn off easily.

A second step is to have one side of the base layer 1, which is provided with no separable layer 3, fixed by an absorption set mode at the inner wall 400 of a female mold 40 of a shaping mold 4, as shown in FIG. 3, or at the outer wall 410 of a male mold 41, as shown in FIG. 4, or at both the inner wall 400 of the female mold 40 and the outer wall 410 of the male mold 41, as shown in FIG. 5. Foresaid absorption mode assists the base layer 1 to tightly adhere to the shaping mold 4 to prevent the base layer 2 from being washed away from its preset position by high-temperature hot melt plastic in a shaping process in the mold and producing serious blemish. Foresaid absorption set mode can adopt the vacuum absorption mode, the electrostatic absorption mode, the water absorption mode or the magnetic absorption mode, depending on the material of the base layer 1. For instance, the majority of materials can adopt the vacuum absorption mode or the water absorption mode, plastic or paper material able to produce electrostatic effect can adopt the electrostatic absorption mode while metallic material can adopt the magnetic absorption mode. Foresaid absorption modes can be used independently or combined and collocated for use to insure that the base layer 1 can be stably positioned in the shaping mold 4 for carrying out in-mold shaping processes smoothly.

A third step is to combine the female mold 40 and the male mold 41 of the shaping mold 4 together and have fluid thermal plastic poured into the shaping mold 4 by means of injection molding, extrusion molding, blow molding, hollow molding or cast molding, as shown in FIG. 6. At this time, the pressure produced when the fluid thermal plastic is poured into the shaping mold 4 will press the inner surface 10 of the base layer 1 and, by tractility of the base layer 1, the plastic in-mold shaping product 2 will be extruded to infiltrate into the gaps of the tri-dimensional ornament 110 of the base layer 1 to form embossed streaks on the surface of the plastic in-mold shaping product 2.

A fourth step is to remove the plastic in-mold shaping product 2 after shaped completely. Since the base layer 1 and the plastic in-mold shaping product 2 are different in material and the separable layer 3 has an isolating effect; therefore, after shaped, the plastic in-mold shaping product 2 and the base layer 1 can be kept in a separable condition. Finally, both the base layer 1 and the separable layer 3 on the surface layer of the plastic in-mold shaping product 2 are torn off, as shown in FIG. 7, and thus, the inner layer or the outer layer or both the inner and the outer layer of the plastic in-mold shaping product 2 will present embossed streaks 20, as shown in FIG. 8.

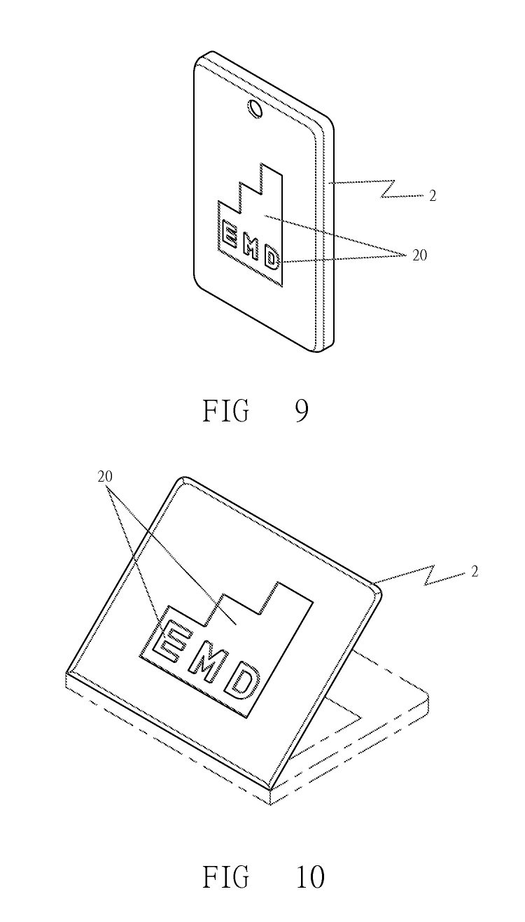

By so designing, the embossment structure formed in a mold and its manufacturing method in the present invention can be applied to communication products, as shown in FIG. 9, computers as shown in FIG. 10, consumption electronic products, electric appliances, machine parts, or plastic or metal in-mold shaping products with a shell, and is also applicable to cups as shown in FIG. 8, cup pads, bottles, boxes, containers, or plastic or metal in-mold shaping products employed in daily life. In this invention, in-mold shaping products can be designed with personalization and individuation to present delicate tri-dimensional embossed streaks for increasing the external beauty and quality feel of the in-mold shaping products. Further, in this invention, it is unnecessary to replace molds repeatedly for different designs of patterns or characters, able to economize resources, having better practicability and conforming to economical gain.

While the preferred embodiments of this invention have been described above, it will be recognized and understood that various modifications may be made therein and the appended claims are intended to cover all such modifications that may fall within the spirit and scope of the invention.

1. A manufacturing method of an embossment structure formed in a mold comprising following steps:
Step one: having a base layer provided with an inner surface and an outer surface, said base layer different from a plastic in-mold shaping product in material, said base layer being a plate with high hardness, able to be engraved and having ductility, said base layer formed with a shape matching the shape of a shaping mold, said base layer having an inner surface engraved with carving streaks, a separable layer provided at said inner surface of said base layer, said separable layer different from said plastic in-mold shaping product in material, said separable layer made of oily material or non-adherent material, said separable layer covered on said carving streaks to prevent said plastic in-mold shaping product from adhering to said carving streaks of said base layer to enable said base layer to be torn off easily;
Step two: having one side of said base layer, which is not provided with said separable layer, fixed in an absorption mold at an inner wall of a female mold of said shaping mold, or at an outer wall of a male mold or at both the inner wall of said female mold and an outer wall of said male mold;
Step three: combining said male mold and said male mold of said shaping mold together and having fluid thermal plastic poured into said shaping mold to let said plastic in-mold shaping product completely cover said carving streaks on the inner surface of said base layer, said plastic in-mold shaping product having a surface forming embossed streaks; and
Step four: removing out said plastic in-mold shaping product after shaped completely and having both said base layer and said separable layer on the surface layer of said plastic in-mold shaping product torn off, said plastic in-mold shaping product having an inner layer or an outer layer or both the inner and the outer layer presenting embossed streaks.

2. The manufacturing method of an embossment structure formed in a mold as claimed in claim 1, wherein said base layer is a metal plate, an acrylic plate a cardboard or a plank.

3. A manufacturing method of an embossment structure formed in a mold comprising following steps:
Step one: having a base layer formed with an inner surface and an outer surface, said base layer being a metal plate, said base layer formed with a shape matching a shape of a shaping mold, said base layer having said inner surface engraved with carving streaks, a separable layer disposed on said inner surface of said base layer, said separable layer being wax able to bear high temperature and high pressure produced when metal is being shaped, said separable layer covered on said carving streaks to insure a metal in-mold shaping product against combining said carving streaks of said base layer and enabling said base layer to be torn off easily;
Step two: having one side of said base layer, which is not provided with said separable layer, secured by magnetic absorption mode at an inner wall of a female mold of a shaping mold or at an outer wall of a male mold, or at both the inner wall of said female mold and the outer wall of said male mold, said magnetic absorption mode assisting said base layer to tightly adhere to said shaping mold to prevent said base layer from being washed away from a preset position by high pressure injecting metal power in a shaping process in the mold;
Step three: having said female mold and said male mold of said shaping mold combined together, and pouring fluid metal powder into said shaping mold with a metal powder injection molding mode, said metal powder injection molding mode enabling said metal in-mold shaping product to completely cover said carving streaks on said inner surface of said base layer, said metal in-mold shaping product having a surface forming embossed streaks; and
Step four: removing said metal in-mold shaping product from said shaping mold after shaped completely, said separable layer between said base layer and said metal in-mold shaping product having isolating effect to keep said metal in-mold shaping product and said base layer in a separating condition, after shaped completely, having both said base layer and said separating layer on the surface layer of said metal in-mold shaping product torn off to present embossed streaks at an inner layer or an outer layer or at both the inner and the outer layer of said metal in-mold shaping product.

4. The manufacturing method of an embossment structure formed in a mold as claimed in claim 3, wherein said metal in-mold shaping product in step four has a surface carrying out polishing or baking varnish to form a polished surface or a baking varnish layer.

5. The manufacturing method of an embossment structure formed in a mold as claimed in claim 1, wherein said carving streaks are engraved on said inner surface of said base layer in a mode of intaglio relief, alto-relievo or embossing.

6. A manufacturing method of an embossment structure formed in a mold comprising following steps:
Step one: having a base layer provided with an inner surface and an outer surface, said base layer and a plastic in-mold shaping product different in material, said base layer being a membrane with tractility, said base layer formed with a shape matching the shape of a shaping mold, said base layer having said outer surface disposed with a tri-dimensional ornament, a separable layer provided at said inner surface of said base layer, said separable layer and said plastic in-mold shaping product being different in material, said separable layer made of oily material or non-adherent material to insure said plastic in-mold shaping product against combining said base layer in a shaping process in a mold to enable said base layer to be torn off easily;
Step two: having one side of said base layer, which is not provided with said separable layer, fixed in an absorption mode at an inner wall of a female mold of a shaping mold or at an outer wall of a male mold or at both the inner wall of said female mold and the outer wall of said male mold;
Step three: having said female mold and said male mold of said shaping mold combined together and having fluid thermal plastic poured into said shaping mold, said plastic in-mold shaping product extruded to filtrate into gaps of said tri-dimensional ornament of said base layer to form embossed streaks on the surface of said plastic in-mold shaping product when said fluid thermal plastic is poured into said shaping mold to produce high pressure to compress said inner surface of said base layer and by tractility of said base layer; and
Step four: removing out said plastic in-mold shaping product after shaped completely and having both said base layer and said separable layer on the surface layer of said plastic in-mold shaping product torn off, embossed streaks able to present at the inner layer or at the outer layer or at both the inner and the outer layer of said plastic in-mold shaping product.

7. The manufacturing method of an embossment structure formed in a mold as claimed in claim 6, wherein said base layer is a plastic membrane or a rubber membrane.

8. The manufacturing method of an embossment structure formed in a mold as claimed in claim 1, wherein said separable layer is isolating oily film, wax or easy-tearing plio-film.

9. The manufacturing method of an embossment structure formed in a mold as claimed in claim 1, wherein said absorption set mode is a vacuum absorption mode, an electrostatic absorption mode, a magnetic absorption mode or a water absorption mode, said absorption mode matching the material characteristics of said base layer, one kind or plural kinds of absorption modes able to be mutually adopted to insure that said base layer is stably fixed in said shaping mold.

10. The manufacturing method of an embossment structure formed in a mold as claimed in claim 1, wherein said fluid thermal plastic is poured into said shaping mold in an in-mold shaping way of injection molding, extrusion molding, blow molding, hollow molding or cast molding.

11. The manufacturing method of an embossment structure formed in a mold as claimed in claim 3, wherein said carving streaks are engraved on said inner surface of said base layer in a mode of intaglio relief, alto-relievo or embossing.

12. The manufacturing method of an embossment structure formed in a mold as claimed in claim 6, wherein said separable layer is isolating oily film, wax or easy-tearing plio-film.

13. The manufacturing method of an embossment structure formed in a mold as claimed in claim 6, wherein said absorption set mode is a vacuum absorption mode, an electrostatic absorption mode, a magnetic absorption mode or a water absorption mode, said absorption mode matching the material characteristics of said base layer, one kind or plural kinds of absorption modes able to be mutually adopted to insure that said base layer is stably fixed in said shaping mold.

14. The manufacturing method of an embossment structure formed in a mold as claimed in claim 6, wherein said fluid thermal plastic is poured into said shaping mold in an in-mold shaping way of injection molding, extrusion molding, blow molding, hollow molding or cast molding.
